(19) United States
(12) Patent Application Publication
(10) Pub. No.: US 2018/0311923 A1
(43) Pub. Date: Nov. 1, 2018

(54) METHOD AND APPARATUS FOR MANUFACTURING A DECORATED PACKAGING MATERIAL, AND A PACKAGING MATERIAL

(71) Applicant: Tetra Laval Holdings & Finance S.A., Pully (CH)

(72) Inventors: Peter Öhman, LUND (SE); Thomas Pettersson, STOCKAMÖLLAN (SE)

(21) Appl. No.: 15/771,955

(22) PCT Filed: Oct. 24, 2016
(86) PCT No.: PCT/EP2016/075547

§ 371 Date: Apr. 27, 2018

(30) Foreign Application Priority Data
Oct. 29, 2015 (EP) EP15192214.3
Nov. 2, 2015 (EP) EP15192604.5

(51) Int. Cl. B31F 1/07; B65H 20/02; B65H 23/188; B41F 19/02

(52) U.S. Cl. CPC B31F 1/07; B65H 20/02; B65H 23/1882; B41F 19/02; B65H 2701/1944; B31F 2201/0779; B65H 2301/5126; B65H 2553/41; B31F 2201/0733

(57) ABSTRACT

In some embodiments, a method for manufacturing a packaging material includes forwarding a web of said packaging material through a nip provided between an anvil roller and an imprint roller which are arranged against each other, said imprint roller having a surface area including an imprinting area and a non-imprinting area, said imprinting area comprising protrusions forming an imprinting pattern. The method can further include imprinting the imprinting pattern into an outermost layer of said packaging material with said imprinting pattern as said web passes through the nip to form a visual or tactile pattern on the packaging material corresponding to said imprinting pattern. The method can further include adjusting the position of said web when said non-imprinting area of said surface area faces said packaging material The disclosure also relates to an apparatus for manufacturing a packaging material and a packaging material.

### TECHNICAL FIELD

The invention relates to a method and apparatus for manufacturing a laminated and decorated packaging material. The invention also relates to a laminated packaging material.

### BACKGROUND ART

Within packaging engineering, consumer packages of a disposable nature are commonly used for packaging and transporting liquid foods, such as, for example, milk. Disposable packages of this type are often made of a laminated packaging material comprising a base layer of paper or cardboard and outer liquid-tight layers of polyethylene. In special cases, such as with particularly oxygen-sensitive foods, for example, fruit juice, it is necessary to supplement the packaging material with at least one further layer of a material having oxygen-tight properties, and the most common example of a supplementary material layer of this kind is an aluminum foil between the paper or cardboard layer and one of the two outer liquid-tight layers.

Consumer packages of this sort are nowadays very often produced with the aid of modern rational packaging machines of the sort which, from a web or from prefabricated blanks of the packaging material, both form, fill and also seal finished packages.

Formed, filled and sealed consumer packages are produced from a web, for example, by the web firstly being transformed into a tube by joining together of the two longitudinal edges of the web into a longitudinal liquid-tight overlap sealing joint. The tube is filled with the particular food, for example, milk, and is divided into connected pillow-shaped pack units by repeated transversal heat sealings of the tube transversely to the longitudinal axis of the tube below the fill product level of the tube. The filled pillow-shaped pack units are separated from one another by cuts in the transverse seals and are subsequently given the desired geometric shape by means of at least one further forming and heat sealing operation. Well-known examples of commercial consumer packages of this kind are Tetra Brik® and Tetra Classic® packages, which are used to transport liquid foods of the type milk, fruit juice, wine and cooking oil.

A laminated packaging material of the sort which is described above is produced on an industrial scale from a roll of paper or cardboard. A web which is unwound from the roll is led to a first work station where one side of the web, by suitable printing technology, is provided with a recurring pattern of an aesthetic and/or informative nature. In conjunction with or directly after the printing, the web is also provided with a likewise recurring pattern of weakening lines facilitating folding (so called fold lines). In order to give the subsequently produced disposable packages the desired shape, function and attractive appearance, it is important that these two recurring patterns are applied to the web in closest possible distance from each other and in register with each other.

The web provided with print and fold lines is led onward to a subsequent work operation, in which the web is coated on both sides with respective outer liquid-tight layers, usually polyethylene. In certain cases, such as when the packaging material is intended for packaging containers for particularly oxygen-sensitive products, the packaging material is also provided with at least one further layer of a material having such barrier properties, for example an aluminum foil, on one side of the packaging material between the paper or cardboard layer and one of the two outer liquid-tight coatings.

There is a desire to complement the printed pattern printed onto the web by an embossed pattern, i.e. an imprinting pattern into the outer, liquid-tight thermoplastic polymer layer of the web of the laminated packaging material, in order to enhance the existing colour-printed pattern and thereby provide an added dimension to the total décor design. The embossing has to be well aligned with the normal printed pattern so as to produce an attractive and acceptable result. That is, however, not as easy to do with rotary embossing operations as with normal printing technologies. With normal printing technology, such as for example in flexographic printing, the longitudinal alignment in the feeding direction of the web relative the printing device has been accomplished with a slight sliding of the web when a misalignment is detected, an adjustment operation that is so small that the effect on the printed result is hardly visible and thereby acceptable. The adjustment operation is possible because the pressure on the material web in the nip between the print rollers is sufficiently low to allow such correction of misalignment. The nature of embossing, where an imprinting surface engages the web by high pressure, especially when the pattern to be imprinted is covering more or less the whole surface of the web, i.e. more than only separate spots or marks or lines, makes such a sliding operation used for traditional printing impossible, however. The nip pressure applied during an embossing or imprinting operation is similar to nip pressures applied during lamination operations. The thus significantly higher pressure of an embossing nip, and the high requirement on the relative position tolerance between the machines handling the web and the web itself in such a nip, are such that imperfections in the alignment of the web will occur.

### SUMMARY OF THE INVENTION

It is an object of the present invention to improve the current state of the art, to solve the above problems, and to provide an improved method for manufacturing a laminated and decorated packaging material.

It is a further object of the invention, to add and superimpose an imprinted pattern of visual and/or tactile nature onto a previously colour-printed pattern on a web of packaging material, at a minimum required register alignment accuracy.

According to a first aspect of the invention, these and other objects are achieved in full, or at least in part, by a method for manufacturing a packaging material. The method comprises the steps of forwarding a web of said packaging material through a nip between two against each other rotatable rollers, said nip being provided by a an anvil roller and an imprint roller, said imprint roller having a mantel surface, i.e. a surface area, provided with a imprinting area and a non-imprinting area, said imprinting area comprising protrusions forming a imprinting pattern, imprinting the imprinting pattern into an outermost layer of said packaging material through engagement with said imprinting pattern, as said web is passing as through the nip, so as to imprint a visual or tactile pattern on the packaging material corresponding to said imprinting pattern of said imprinting area, and adjusting the position of said web and/or the rotational position of the imprint roller when said non-imprinting area of said surface area is facing said packaging material. The method has been developed in order to allow adjustment of the web position relative the imprint roller so that intended effects are in register with the package material (and the print design of the package material). Accordingly, the step of adjusting the position of said web relative the imprint roller may be performed in register with a register mark on said web.

The method may be used both for micro-imprinting patterns, i.e. imprinting only the top surface of the material, and for deeper imprinting patterns. The positioning of the web is made when the non-imprinting area of the imprint roller is facing the packing material. When the imprint pattern of the imprint roller engages the packaging material adjustment of the positioning of the web is not possible since the imprint pattern physically hinder any adjusting movement of the web.

The packaging material may be a laminated and/or decorated packaging material. Imprinting, micro-imprinting or nano-imprinting may be applied only on a top layer or top layers of the laminated packaging material. The imprinting may also be applied deeper into the packaging material layer(s) (in relation to the material thickness). The imprint may also be aligned with any decoration or repetitive pattern already present on the packaging material.

The method may further comprise the step of controlling the tension of said web of packaging material in a longitudinal direction of said web, i.e. the machine direction, by means of a tension control device. Should any deviation occur it can easily be overcome by means of the adjustment step described above.

According to an embodiment of the invention, the packaging material is a laminated packaging material comprising a core layer of a paper or paperboard and outer, liquid-tight layers of a thermoplastic polymer. According to a further embodiment, the laminate material has a gas barrier layer, such as an aluminium foil, arranged between the core layer and one of the outer layers. According to a yet further embodiment, the core layer is a paperboard have a density higher than 500 kg/m³, such as higher than 700 kg/m³. According to a further embodiment, the paperboard has a thickness from 150 to 660 μm, such as from 200 to 500 μm, such as from 250 to 400 μm. According to a further embodiment, the paperboard has a bending stiffness from 30 to 480 mN, such as from 80 to 300 mN.

According to a second aspect of the invention, the objects are achieved in full, or at least in part, by an apparatus for manufacturing an embossed or imprinted packaging material. The apparatus comprises an anvil roller and an imprint roller which are arranged against each other to create a nip therebetween, said imprint roller having a surface area provided with an imprinting area, said imprinting area comprising protrusions forming an imprinting pattern, and a conveyor arrangement adapted to forward a web of said packaging material through said nip, so as to imprint a visual or tactile pattern on the packaging material corresponding to said imprinting pattern. The surface area is further provided with a non-imprinting area designed to disengage said nip when said non-imprinting area is facing packaging material. According to an embodiment, the imprint roller has a surface area (sleeve) of metal, such as steel. According to a further embodiment the anvil roller has a hardness from 80 Shore A and higher, such as from 90 Shore A and higher, such as from 95 Shore A and higher, such as from 98 Shore A and higher. The apparatus has been developed in order to allow adjustment of the web position so that intended effects are in register with the package material (and the print design of the package material). According to an embodiment, the register alignment accuracy should be from ±1 mm to ±0.1 mm. Thus, the apparatus may further comprise an adjustment device arranged to adjust the position of said web when said non-imprinting area of said surface area is facing said outermost layer of said packaging material, wherein the adjustment is based on a register mark on the web.

The apparatus may further comprise a tension control device adapted to control the tension of said web of packaging material in a longitudinal direction of said web of packaging material, and a control unit arranged to control the apparatus. The control unit is arranged to control the tension device. The automated apparatus reduces labor needs and makes the method faster. It further enables an imprinting/embossing web speed, which is industrially and economically feasible. Detectors such as scanners or cameras are used to detect detection marks of the web in relation to the printed patterns and imprint pattern with a view to detect if the web imprint is correctly placed in relation to previously printed areas of the web or crease lined etc on the web. Costs are thereby saved in two ways, both by reducing labor costs and by reducing the number of devices needed for repairing defects in webs of packaging material. Human errors are also avoided, providing a higher degree of certainty that all errors in alignment of the decorative printing and the embossing of a web of packaging material have been removed.

In a preferred embodiment of the invention, the imprint roller may have the cross-section of a truncated circle, wherein said non-imprinting area is constituted by the portion of said surface area corresponding to the truncated portion of said cross-section. Alternatively, the anvil roller may have the cross-section of a truncated circle, wherein said non-imprinting area is aligned with the portion of said anvil roller corresponding to the truncated portion of said cross-section.

The imprint mantel or embossing sleeve of said imprint roller may be releasably attached. This may, for example, be implemented by arranging a joint or sleeve attachment device in the portion of said imprint roller corresponding to the truncated portion of said cross-section. Such a design is advantageous if the imprinting sleeve needs to be exchanged due to wear, or if another imprinting pattern is to be provided on the packaging material that is processed in the apparatus.

The non-imprint area of the surface area may be made of a softer material that is easier to compress than the imprint area of the surface area. If the nip of the imprint roller to the packaging material is controlled by position or distance between the rollers and not by nip pressure, the pressure between the imprint roller and the packaging material will decrease when the non-imprint area passes the packaging material. The position of the web in relation to the imprint pattern on the imprint roller may then be corrected by quickly and momentarily sliding the packaging material into correct position, while the non-imprint area faces the packaging material. However, controlling the nip by pressure may also benefit from a softer material of the non-imprint area, since a more gentle action on the web is accomplished.

According to a third aspect of the invention, the objects are achieved in full, or at least in part, by a packaging material, exhibiting a visual or tactile pattern, or a combination thereof, manufactured according to the method described above and/or using the apparatus described above.

According to a further embodiment, there is provided a laminated packaging material (1), exhibiting a visual or tactile pattern, or a combination thereof, in a first outermost layer of said laminated packaging material (1), manufactured according to the method described above and/or using the apparatus described above.

A person skilled in the art understands that the same advantages as discussed in relation to the features of the inventive method are also true for the corresponding features of the inventive device.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise.

### BRIEF DESCRIPTION OF THE DRAWINGS

The above objects, as well as additional objects, features and advantages of the present invention, will be more fully appreciated by reference to the following illustrative and non-limiting detailed description of preferred embodiments of the present invention, when taken in conjunction with the accompanying drawings, wherein:

FIG. 1 is a side view of an anvil roller and an imprint roller which are arranged against each other to create a nip therebetween in accordance with known prior art.

FIG. 2 is a side view of an apparatus for manufacturing a packaging material according to one exemplary embodiment of the invention.

FIG. 3 is a side view of the anvil roller and the imprint roller arranged against each other to create a nip therebetween in accordance with another exemplary embodiment of the invention.

FIG. 4 is a flow chart of a method for manufacturing a packaging material according to one exemplary embodiment of the invention.

### DETAILED DESCRIPTION OF PREFERRED EMBODIMENTS OF THE INVENTION

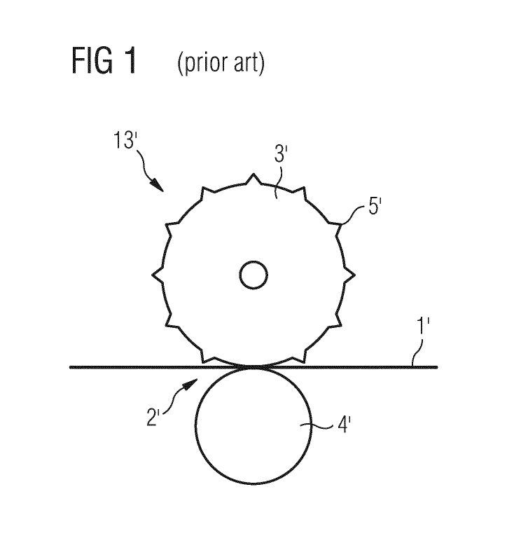

FIG. 1 shows a prior art solution of an apparatus 13′ for manufacturing an imprinted or embossed packaging material. A web of packaging material 1′ is forwarded into the nip 2′ between an imprint roller 3′ and an anvil roller 4′. The high imprinting nip pressure and the protrusions 5′ of the imprint roller 4′ engaging the web of packaging material 1′ makes it impossible to adjust the alignment of the web of packaging material 1′.

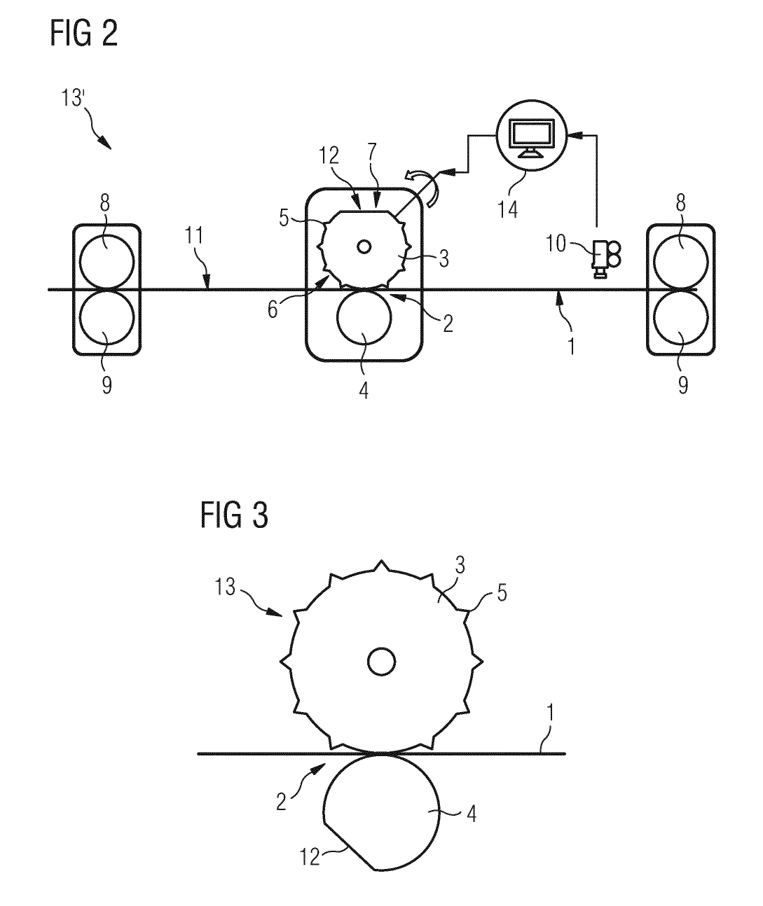

FIG. 2 shows a first embodiment of the present invention. A web of packaging material 1 is forwarded into the nip 2 between an imprint roller 3 and an anvil roller 4. The protrusions 5 of the imprint roller 3 engages the web of packaging material 1 only when an imprinting area 6 of the imprint roller 3 is facing the web of packaging material 1 and the anvil roller 4. When the non-imprinting area 7 of the imprint roller 3 is facing the web of packaging material 1 and the anvil roller 4, the web packaging material 1 is not engaged with the rollers 3, 4 (i.e. the protrusions 5 of the imprint roller 3 are not in engagement with the web of packaging material 1) and is thereby free to be adjusted. As is seen in FIG. 2, the imprint roller 3 has the cross-section of a truncated circle, where the non-printing area 7 is constituted by the portion of the surface area of the cross-section corresponding to the truncated portion 12. For such embodiment, the anvil roller 4 is preferably provided with a flat surface area having a circular cross-section. This means that no rotational alignment is required between the anvil roller 4 and the imprint roller 3.

Still referring to FIG. 2, the non-imprinting area 7 is preferably arranged so that it is aligned with a portion of the web package material 1 that is intended for a part of the final package product where no embossing or imprinting is placed, e.g. the bottom or top parts of the package. A sensor 10 for detecting the alignment of the web of packaging material 1, in this embodiment a camera, is placed so as to detect the position of register marks 11 on the web of packaging material 1. The position of a detected register mark 11 is sent to a control unit 14 where it is compared with a database value of an expected position. If any discrepancy in the feeding direction and/or cross direction of the web of packaging material 1 is detected, the positioning of the web of packaging material 1 is adjusted accordingly by the tension control device in the form of pull and brake rollers 8, 9. The pull and break rollers 8, 9 are placed on each side of the nip 2 when the non-imprinting area 7 of the imprint roller 3 is facing the web of packaging material 1. The imprint roller 3 is further driven by a motor (not shown) that is controlled by the control unit 14.

Optionally, or in combination with the web positioning described above, the alignment of the web of packaging material 1 is determined by means of the sensor 10 and the control unit 14. Such alignment is preferably analyzed by determining the relative position of the imprinted pattern in view of the position of the register mark(s). If correction is required, e.g. if the actual position of a part of the imprinted pattern is located outside a pre-determined or desired area of the packaging material 1, the control unit 14 is configured to adjust the current rotational position of the imprint roller 3. This is possible due to the truncated circular cross-section of the imprint roller 3. When the imprint roller 3 is in a position in which the non-printing area 7 is facing the web of packaging material 1 it will be possible to rotate the imprint roller 3 slightly without risking engagement between the imprinting area 6 and the web of packaging material 1. In practice this means that when the control unit 14 determines that the location of the imprinted pattern on the web of packaging material 1 deviates from the desired position, a control signal is transmitted to the drive unit (not shown) of the imprint roller 4. Upon receiving the control signal the drive unit is configured to i) determine when the non-imprinting area 7 is facing the web of packaging material 1, and upon this ii) decelerate or accelerate the rotation of the imprint roller 3 slightly such that the subsequent imprint pattern is positioned correctly.

FIG. 3 shows an alternative embodiment of the invention. The web of packaging material 1 is forwarded into the nip 2 between an imprint roller 3 and the anvil roller 4. In this embodiment the anvil roller 4 has a flat surface and a cross-section of a truncated circle, while the imprint roller 3 has a circular cross-section. When the anvil roller 4 is positioned such that a portion of the surface area of the cross-section corresponding to the truncated portion 12 is facing the imprint roller 3, the imprint roller 3 will be disengaged from the web of packaging material 1 so that the position of the web of packaging material 1 is free to be adjusted. Alternatively, or in combination, correction of the position of the imprint pattern relative the register mark(s) is performed by adjusting the rotational position of the imprint roller 3 as described above.

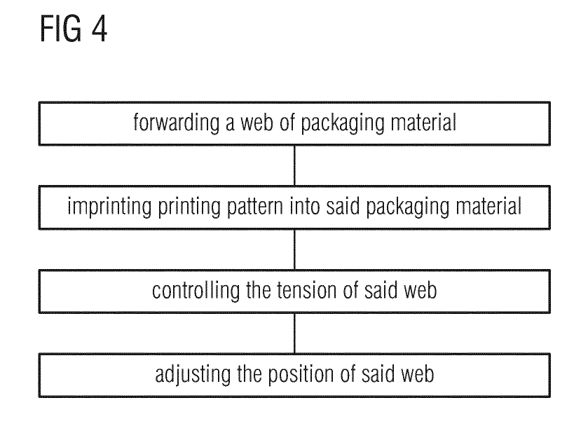

FIG. 4 is a block diagram showing the inventive method of the present invention. The web of packaging material 1 is forwarded by a conveyor arrangement (not shown) through the nip 2, see FIGS. 2 and 3, provided between the anvil roller 4 and the imprint roller 3 which are arranged against each other. The imprint roller 3 has a surface area provided with an imprinting area 6 and a non-imprinting area 7 and the imprinting area 6 comprises protrusions 5 forming a imprinting pattern. Alternatively, the entire surface area of the imprint roller 3 is provided with an imprinting area 6, while the anvil roller 4 is provided with a truncated circular cross-section as described with reference to FIG. 3.

The of web of packaging material 1 is provided with an embossed pattern when the imprint roller 3 is engaging the web of package material 1 against the anvil roller 4 so as to imprint a visual and/or tactile pattern on the packaging material corresponding to the imprinting pattern of the imprinting area. In the case of a laminated packaging material, the embossed pattern may be made in the outermost or outer layers only. The tension of the web is controlled by a tension control device consisting of pull and brake rollers 8, 9. When the truncated parts of the imprint roller 3 in FIG. 2, or alternatively of the anvil roller 4 in FIG. 3, are facing the web of packaging material 1, there will be no engagement between the imprint roller 3 and the web of packaging material 1, such that a step of adjusting the position of the web can be performed if any discrepancy of the position of the web has been detected. The adjustment is especially made in a longitudinal direction of the web by means of the tension control device 8, 9 in relation to any discrepancy detected by the sensor 10, and/or by correcting the rotational position of the imprint roller 3. The discrepancy is determined by the control unit 14 by comparing the position of register marks 11 on the packaging material 1 detected by the sensor 10 and values stored in a database. In that way, detection and adjustment of the position of the web of packaging material 1 may be fully automated.

The skilled person realizes that a number of modifications of the embodiments described herein are possible without departing from the scope of the invention, which is defined in the appended claims.

1. A method for manufacturing a packaging material, the method comprising the steps of:
forwarding a web of said packaging material through a nip provided between an anvil roller and an imprint roller, wherein the anvil roller and the imprint roller are arranged adjacent to each other, said imprint roller having a surface area including an imprinting area distributed over at least a portion of the surface area, wherein one of said imprint roller and said anvil roller has a circular cross-section and the other of said imprint roller and said anvil roller has a truncated circular cross-section, said imprinting area comprising protrusions forming an imprinting pattern;
imprinting the imprinting pattern into an outermost layer of said packaging material through engagement with said imprinting pattern as said web passes through the nip to form a visual or tactile pattern on the packaging material corresponding to said imprinting pattern of said imprinting area; and
adjusting a position of said web relative to the imprint roller when a truncated part of the imprint roller or of the anvil roller faces said packaging material.

2. The method according to claim 1, further comprising the step of controlling the tension of said web of packaging material in a longitudinal direction of said web with a tension control device.

3. The method according to claim 1, wherein said step of adjusting the position of said web relative the imprint roller is performed in register with a register mark on said web.

4. The method according to claim 1, wherein adjusting the position of the web relative to the imprint roller is performed by adjusting a rotational position of the imprint roller.

5. An apparatus for manufacturing a packaging material, comprising:
an anvil roller and an imprint roller arranged adjacent to each other to create a nip therebetween, said imprint roller having a surface area including an imprinting area distributed at least over a portion of the surface area, said imprinting area comprising protrusions forming an imprinting pattern;
a conveyor arrangement configured to forward a web of said packaging material through said nip to imprint a visual or tactile pattern on the packaging material corresponding to said imprinting pattern on the surface area of the imprint roller, wherein one of said imprint roller and said anvil roller has a circular cross-section and the other of said imprint roller and said anvil roller has a truncated circular cross-section; and
a controller configured to adjust a position of said web relative to the imprint roller.

6. The apparatus according to claim 5, wherein the controller is configured to adjust a rotational position of the imprint roller when a truncated part of the imprint roller or of the anvil roller faces the packaging material.

7. The apparatus according to claim 5, wherein the controller is configured to adjust the position of the web relative to the imprint roller by adjusting the rotational position of the imprint roller.

8. The apparatus according to claim 5, further comprising a tension control device configured to control the tension of said web of packaging material in a longitudinal direction of said web of packaging material.

9. The apparatus according to claim 5, wherein the controller is configured to adjust the position of the web relative the imprint roller based on a register mark on the packaging material.

10. The apparatus according to claim 9, further comprising a sensor configured to detect said register mark.

11. The apparatus according to claim 5, wherein said imprint roller has a truncated circular cross-section, and wherein the surface area of the imprint roller further includes a non-imprinting area corresponding to a truncated portion of the truncated circular cross-section of the imprint roller.

12. The apparatus according to claim 11, wherein the non-imprinting area of said surface area comprises a softer material than the imprinting area of said surface area.

13. The apparatus according to claim 5, wherein the imprinting area of said imprint roller is releasably attached.

14. The apparatus according to claim 13, wherein said releasably attached imprinting area has a joint arranged in the non-imprinting portion of said surface area corresponding to the truncated portion of said truncated circular cross-section.

15. The packaging material, exhibiting the visual or tactile pattern, or a combination thereof, manufactured according to the method of claim 1.

16. The packaging material, exhibiting the visual or tactile pattern, or a combination thereof, in a first outermost layer of said packaging material, manufactured using the apparatus of claim 5.
